(19) United States
(12) Patent Application Publication
(10) Pub. No.: US 2021/0357983 A1
(43) Pub. Date: Nov. 18, 2021

(54) SYSTEM FOR PRESENTING ADVERTISEMENTS ONLINE AND METHOD THEREOF

(71) Applicant: NANNING FUGUI PRECISION INDUSTRIAL CO., LTD., Nanning (CN)

(72) Inventors: RUI-TANG HUANG, New Taipei (TW); YI-CHE HSIEH, New Taipei (TW)

(21) Appl. No.: 16/874,600

(22) Filed: May 14, 2020

(51) Int. Cl. G06Q 30/02; G06F 40/30

(52) U.S. Cl. CPC G06Q 30/0269; G06Q 30/0256; G06Q 30/0254; G06F 40/30; G06Q 30/0246; G06Q 30/0277; G06Q 30/0272

(57) ABSTRACT

A method for presenting advertisements online includes recording search history, user reactions corresponding to each pushed advertisement, and application usage record of the user. Preference scores for different search words of the user are allocated and recorded based on the search history, the user reactions, and the application usage record. At least one new advertisement is presented according to words included in the new advertisement and the preference score.

### FIELD

The application relates in general to advertising online, and in particular to the advertisement push methods and systems of deciding which advertisement to push based on the user's search history, reactions corresponding to each pushed advertisement, and application usage records.

### BACKGROUND

Existing multimedia players also serve as a platform for various software services. For operators, hardware devices used to play multimedia are no longer a main source of revenue, and attracting users to continue to purchase online services is necessary. However, despite various types of notification channels between users and operators, when faced with large amounts of marketing notifications, users can easily turn off notifications and ignore information important to the operators. Selecting advertisements to which the user will respond is problematic.

### BRIEF DESCRIPTION OF THE DRAWINGS

Implementations of the present technology will now be described, by way of example only, with reference to the attached figures, wherein:

FIG. 1 is a block diagram of a system for presenting advertisements in accordance with an embodiment of the disclosure;

FIG. 2 is a flow chart of a method for presenting advertisements in accordance with an embodiment of the disclosure.

### DETAILED DESCRIPTION

Further areas to which the present disclosure can be applied will become apparent from the detailed description provided herein. It should be understood that the detailed description and specific examples, while indicating exemplary embodiments, are intended for purposes of illustration only and are not intended to limit the scope of the claims.

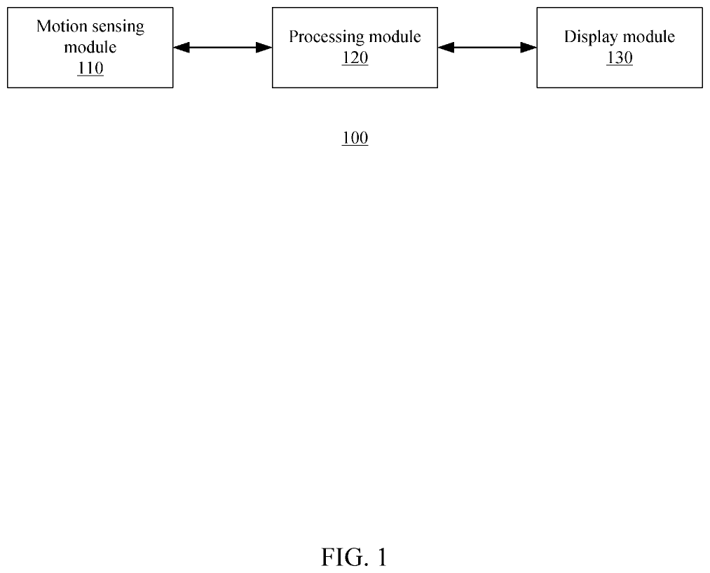

FIG. 1 is a block diagram of the system 100 for presenting advertisements in accordance with an embodiment. The system 100 includes at least a motion sensing module 110, a processing module 120, and a display module 130. The motion sensing module 110 includes a general TV remote control (or remote control application implemented on a handheld device) for users to input search terms and operation instructions and an eye tracker for detecting whether the user's eyes are watching the content of the advertisement. The processing module 120 can be a processor provided in a smart TV or an OTT (Over The Top) Box, such as dedicated hardware circuits or general-purpose hardware (e.g., a single processor, a multi-processor with parallel processing capabilities, a graphics processor, or other computing capabilities processor), and is able to provide the functions described below. The display module 130 can be a display panel (such as a thin-film liquid crystal display panel, an organic light-emitting diode panel, or other display-capable panels) for displaying characters, numbers, symbols, control indicators output by the processing module 120, or user interface provided by the applications. In addition, the advertisement push system 100 may further include a storage module (not shown in FIG. 1) for storing data and various electronic files for the execution process, such as various algorithms, setting parameters corresponding to each user, preference data, browsing history, and word database, etc. It should be noted that the foregoing descriptions of the motion sensing module, the processing module, and the display module are only examples, the disclosure is not limited thereto.

According to an embodiment, after receiving the advertisement, the processing module 120 directly presents the advertisement to the user through the display module 130 if there is only one advertisement, and records the user's reactions. Otherwise, the processing module 120 will select an advertisement that the user may be interested in according to the words contained in the advertisement and the user's word database to improve the efficacy of the presentation if there are more than one advertisement. The preference scores of different words corresponding to each user are calculated based on each user's search history, reactions corresponding to advertisements, and application usage records. Further, the user reactions include the watching duration of the user looking at the content of the advertisement, the user's clicking records and bookmarking records corresponding to the advertisement, and the application usage records including the usage time of each application, the number of clicks (the number that the user clicked the application corresponding to the pushed advertisements) corresponding to the clicking records and the bookmarked times (the number that the user bookmarked the pushed advertisement) corresponding to the bookmarking records.

When the user searches through the motion sensing module (such as by pressing buttons or voice inputting), the processing module 120 will give a certain word used in the search a search weight (such as 50), and accumulate the scores of the corresponding words stored in the word database. For example, if the user searches for “costume drama”, if the original preference score for the “costume drama” in the word database is 20, after the user search, the preference score for the “costume drama” will be 70. Conversely, if “costume drama” is not stored in the word database, the processing module 120 adds the phrase “costume drama” and records its preference score as 50.

In addition, after the display module 130 displays the advertisement, the processing module 120 further determines the user's reactions, and calculates the preference scores for the words contained in the advertisement according to the reactions. The words in the advertisement can be obtained through any general word division method, and the user's reactions include the watching duration of the user looking at the content of the advertisement, whether the user clicked on the application corresponding to the advertisement (clicking record) and whether the user bookmarked the advertisement (bookmarking record), etc.. If the user clicked on the application corresponding to the advertisement, the processing module 120 multiplies the scores of all the words included in the advertisement by a click weight (such as 1.2). If the user bookmarks the advertisement information, the processing module 120 further multiplies the scores of all the words included in the advertisement by a bookmark weight (such as 1.5). The preference score corresponding to each word contained in each advertisement is the product of the watching duration, the click weight, and the bookmark weight. It should be noted that the values of the click weight and the bookmark weight can be defined by the user, but are usually less than the search weight. In other words, after the user searches using a certain word, the increase in its preference score is usually much greater than the increase in clicking and/or bookmarking in relation to certain advertisements. Finally, after obtaining the user's preference scores corresponding to different words, when the processing module 120 receives further advertisements, the further advertisement can be selected according to the words contained in each of the advertisements with higher preference scores to improve the efficacy of the presentation. In addition, if there is only one further or new advertisement, the processing module 120 directly pushes the new advertisement, records the reactions of the user, and updates the preference scores of all words contained in the new advertisement according to the reactions.

According to another embodiment, the processing module 120 further determines a viewing situation in which to play the new advertisement based on the product of a ratio of the watching duration and residing time of the advertisement, and a ratio of the number of clicks and the number of all advertisements. The residing time of the advertisement represents the time from the display module 130 displaying the advertisement until the user closes the display of the advertisement. The viewing situation for playing the advertisement may include playing the advertisement before executing the application, playing the advertisement after leaving the application, and playing the advertisement during idle mode (such as after leaving the application for a predetermined time). It should be noted that the viewing situations for playing advertisements as described above are only some examples and are not limited thereto.

When the watching duration and the residing time are closer in duration, and the more that the user clicks on the applications related to the advertisement, this is taken to signify a better user-reaction and the higher the calculated value. Conversely, when the ratio of the watching duration and the residing time is smaller, or the number of clicks is less, the calculated value will be lower, as it is taken to indicate that the user did not specifically watch the content of the advertisements, that is, the efficacy of such advertising is not high. Finally, when the processing module 120 is to put forward a further or new advertisement, it will preferentially select the viewing situation having the highest product value.

According to another embodiment, the processing module 120 further determines the time point of the presentation of the advertisement according to the delay between clicks (click-delay) in each application. For example, the processing module 120 records the time point of each operation (such as pressing any key on the remote control) implemented on the motion sensing module 110 by the user in the application, and calculates the click-delays between each time point. Next, the processing module 120 groups the click-delays into multiple clusters, and selects the maximum delay of the largest cluster as the time point for presenting the new advertisement. For example, the processing module 120 divides the clusters of the click-delays into 1-3 seconds, 5-10 seconds, and 30-180 seconds categories, and counts the number of click-delays falling within the three clusters in each application. If the number of click-delays falling within 1-3 seconds is the largest, the processing module 120 pushes the new advertisement 3 seconds after the user presses any key on the remote control. If the number of click-delays falling within 5-10 seconds is the largest, the processing module 120 pushes the new advertisement 10 seconds after the user presses any key on the remote control. If the number of click-delays falling within 30-180 seconds is the largest, the processing module 120 pushes the new advertisement 180 seconds after the user presses any key on the remote control. In this way, the advertisements can be most effectively pushed to the user, and there is no inconvenience or annoyance caused to the user.

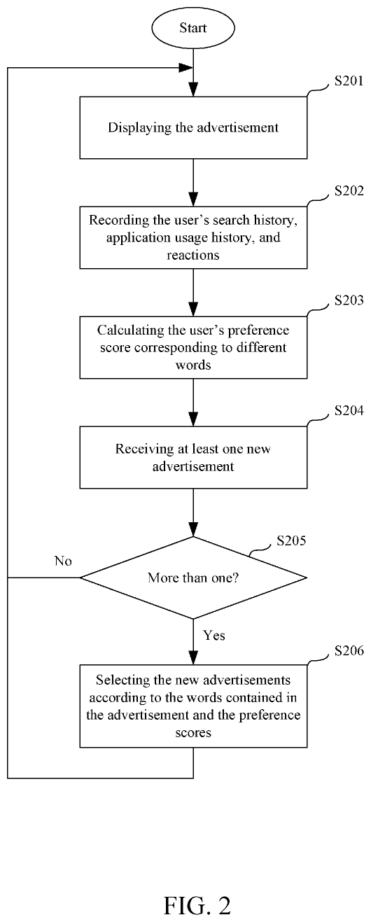

FIG. 2 is a flowchart of a method for presenting advertisements in accordance with an embodiment. First, at step S201, the processing module 120 displays the advertisement through the display module 130. At step S202, the processing module 120 records the user's search history, application usage history, and reactions corresponding to the advertisement displayed by the display module 130. The reactions include watching duration that the user looked at the content of the advertisement, clicking record, and bookmarking record corresponding to the advertisement. The application usage record includes the usage time of each application, the number of clicks corresponding to the record of the click record, and bookmarked times corresponding to the bookmarking record. At step S203, the processing module 120 calculates the user's preference score corresponding to different words according to the user's search history, reactions, and application usage record. Next, the method proceeds to step S204, the processing module 120 receives at least one further or new advertisement again. At step S205, in order to avoid pushing too much advertisement, after receiving the at least one new advertisement, the processing module 120 further determines that the number of advertisements. If there is only one advertisement, then the method returns to step S201, the processing module 120 displays the new advertisement through the display module 130, and repeats the foregoing steps to recalculate the preference score of each word included in the new advertisement. Otherwise, if there are two or more advertisements, the method proceeds to step S206, the processing module 120 selects the pushed new advertisement according to the words contained in the advertisement and preference scores stored in the word database, and then returns to step S201, the processing module 120 pushes the advertisement.

In addition, before pushing the advertisement, the processing module 120 may further decide the viewing situation to be pushed according to the residence time, the watching duration, the click record and bookmark record of the displayed advertisements, and decide the time point according to the user's click-delays in each application. The methods of determining the viewing situation and the time point of the presentation of the advertisement are as described above, and it will not be described again to simplify the description.

It should be noted that although the method as described above has been described through a series of steps or blocks of a flowchart, the process is not limited to any order of the steps, and some steps may be different from the order of the remaining steps or the remaining steps can be done at the same time. In addition, those skilled in the art should understand that the steps shown in the flowchart are not exclusive, other steps may be included, or one or more steps may be deleted without departing from the scope.

In summary, according to the advertising information pushing method and system described in the embodiments of the present invention, by recording the user's search history, application usage records, and the user's reactions corresponding to each advertisement, the user's preference habits can be utilized, so as to select the advertisements that the user may be interested in, so as to improve the effectiveness of the advertisement. In addition, by recording the user's operating habits in different viewing situations and the user's click-delays in each application, it will be possible to deduce the user's browsing habits, attention time to information, and the time when the continuous operation is not disturbed. This will enable users to focus more on information that is interest or importance, and reduce the bandwidth required by not sending unneeded background information.

It will be apparent to those skilled in the art that various modifications and variations can be made to the structure disclosed without departing from the scope or spirit of the claims. In view of the foregoing, it is intended that the present disclosure covers modifications and variations, provided they fall within the scope of the following claims and their equivalents.

What is claimed is:

1. An advertisement push method, comprising the steps of:
recording search history, reactions to each pushed advertisement, and application usage record of a user;
calculating preference score corresponding to different words of the user based on the search history, the reactions and the application usage record; and
selecting at least one new advertisement to be pushed according to the words included in the new advertisement and the preference score.

2. The advertisement push method as claimed in claim 1, wherein the reactions include watching duration that the user looked at a content of the advertisement, clicking record, and bookmarking record corresponding to the advertisement; and the application usage record includes usage time of each application, the number of clicks corresponding to the clicking record, and bookmarked times corresponding to the bookmarking record.

3. The advertisement push method as claimed in claim 1, wherein the steps further comprising:
counting residence time, the watching duration, the clicking record and the bookmarking record of the pushed advertisement displayed in different viewing situations;
calculating product value corresponding to each of the viewing situations according to a ratio of the watching duration and the residence time, and a ratio of the clicking record and number of the pushed advertisements; and
selecting the viewing situation having the largest product value as the viewing situation for playing the new advertisement.

4. The advertisement push method as claimed in claim 3, wherein the viewing situations include the viewing situation of entering an application, the viewing situation of leaving the application, and the viewing situation of an idle mode.

5. The advertisement push method as claimed in claim 1, wherein the steps further comprising:
recording click pitch in each of the applications, and grouping the click-delays into multiple clusters; and
selecting a maximum delay of the largest cluster as the time point for presenting the new advertisement.

6. An advertisement push system, comprising:
a display module for displaying pushed advertisements;
a motion sensing module for receiving search input of a user and reactions of the user corresponding to the pushed advertisements;
a processing module for calculating preference scores of different words of the user based on the search history, the reactions and application usage record, and selecting at least one new advertisement to be pushed according to words included in the new advertisement and the preference score.

7. The advertisement push system as claimed in claim 6, wherein the reactions include watching duration that the user looked at a content of the pushed advertisement, clicking record and bookmarking record corresponding to the pushed advertisement, and the application usage record includes usage time of each application, the number of clicks corresponding to clicking record, and bookmarked times corresponding to the bookmarking record.

8. The advertisement push system as claimed in claim 6, wherein the processing module further counts residence time, the watching duration, the clicking record, and the bookmarking record of the pushed advertisement displayed in different viewing situations; calculates product value corresponding to each of the viewing situations according to a ratio of the watching duration and the residence time, and a ratio of the clicking record and number of the pushed advertisements; and selects a viewing situation having the largest product value as the viewing situation for displaying the new advertisement.

9. The advertisement push system as claimed in claim 8, wherein the viewing situations include the viewing situation of entering an application, the viewing situation of leaving the application, and the viewing situation of an idle mode.

10. The advertisement push system as claimed in claim 6, wherein the processing module further records click-delays in each of the pushed applications, and grouping the click-delays into multiple clusters, and selects a maximum delay of the largest cluster as a time point for presenting the new advertisement.
